(19) United States
(12) Patent Application Publication
(10) Pub. No.: US 2005/0099680 A1
(43) Pub. Date: May 12, 2005

(54) Arrangement for the fine-focussing of microscopes

(76) Inventors: Johannes Knoblich, Jena (DE); Tobias Kaufhold, Jena (DE); Johannes Winterot, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/415,045

(22) PCT Filed: Dec. 18, 2001
(86) PCT No.: PCT/EP01/14917

(30) Foreign Application Priority Data
Jan. 16, 2001 (DE) 101 01 624.7

(51) Int. Cl. G02B 21/00

(52) U.S. Cl. 359/368

(57) ABSTRACT

The invention is directed to an arrangement for the focusing of microscopes, preferably for stereo microscopes, with a drive unit for the focusing movement in the Z-coordinate direction and with elements for monitoring the focusing on a plurality of different positions z₁, z₂ . . . zₙ located within an observed object on coordinate Z. A path measuring system is provided for determining the adjusting path Δz during a change in the focus from a first selected position z₁ to a second selected position z₂. Further, there is a display device that is coupled with the path measuring system for displaying the selected positions z₁, z₂ and/or for displaying a measurement for the adjusting path Δz. According to the invention, the objective assessment of focus which is made possible in this way is used to increase accuracy in depth measurements.

### CROSS-REFERENCE TO RELATED APPLICATIONS

This application claims priority of International Application No. PCT/EP01/14917, filed Dec. 18, 2001 and German Application No. 101 01 624.7, filed Jan. 16, 2001, the complete disclosures of which are hereby incorporated by reference.

### BACKGROUND OF THE INVENTION

a) Field of the Invention

The invention is directed to an arrangement for the focusing of microscopes, preferably for stereo microscopes, with a drive unit for the focusing movement in the Z-coordinate direction and with means for monitoring the focusing on a plurality of different positions z₁, z₂ . . . zₙ located within an observed object on coordinate Z.

b) Description of the Related Art

An essential prerequisite for exact microscopic observation is focusing or sharpness adjustment on the areas of interest at the surface or within the depth of a specimen. With regard to depth in the specimen, these areas of interest could be, for example, the boundary areas between a plurality of more or less transparent layers lying one on top of the other in the Z-coordinate direction. When a microscope with a small depth of focus is used, each of these optical boundary layers which are offset in depth can be focused separately.

The focusing movement which is required for this purpose from one boundary layer to the next boundary layer or, generally, from one focus position to the next focus position, is realized in conventional microscope construction by means of gear units which are to be actuated manually and which have large gear ratios and a high sensitivity of adjustment. In this connection, a focusing movement can be achieved on the order of magnitude of 1 μm, for example, by the rotation or displacement of a drive knob.

When a gear unit of the type mentioned above is used in connection with a linear measurement graduation, it is possible to read off and calculate the adjusting path which must be traveled during the adjustment from a first focus position to a second focus position. In this way, it is possible up to a certain degree of accuracy to carry out depth measurements on the object under the microscope.

### OBJECT AND SUMMARY OF THE INVENTION

Proceeding from this prior art, it is the primary object of the invention to enable an improved assessment of focus and accordingly to increase accuracy in depth measurements.

According to the invention, in a microscope of the type described above, namely, in a microscope with a motor drive unit for the focusing movement and with means for monitoring the focus on individual positions z₁, z₂ . . . zₙ within the observed object, a path measuring system is provided for determining the adjusting path Δz during a change in the focus from a first selected position z₁ to a second selected position z₂; further, there is a display device that is coupled with the path measuring system for displaying the selected positions z₁, z₂ and/or for displaying a measurement for the adjusting path Δz.

In this way, the motor drive unit which is provided in the prior art for the focusing movement is utilized, according to the invention, for depth measurement.

It is further provided, according to the invention, that the motor drive unit and the path measuring system are coupled with one another. A stepping motor is preferably used as drive unit and the measurement for the adjusting path Δz is obtained from the quantity of drive steps required for the adjusting path Δz.

In order to determine the quantity of drive steps, the control electronics for the stepping motor, which already exist in the microscope, can be used or these control electronics can be supplemented by an evaluating circuit for the quantity of drive steps traveled when adjusting by path Δz.

The display device can be designed in such a way that the first selected position z₁ is displayed, and this display is also retained when this position z₁ is exited, whereupon when the second selected position z₂ is reached, this position is also displayed. The difference between the two displayed position values can now easily be calculated and serves as a measurement for the traveled adjusting path Δz and, accordingly, for the depth to be determined within the specimen.

Alternatively, the path measuring system can be constructed in such a way in connection with the display device that the value of “zero” is set for the first selected position z₁ after this position z₁ has been focused on. When position z₂ is focused on proceeding from position z₁ and the measurement for the adjusting path Δz that has been traveled is obtained from the quantity of drive steps, this measurement can be displayed directly as a depth measurement without first having to perform a subtraction.

Of course, positions z₁, z₂ as well as the adjusting path Δz can be displayed.

Further, it is possible to use a conventional motor instead of the stepping motor and instead of the counting device for the drive steps of the stepping motor and to outfit this conventional motor with a rotational angle transmitter which periodically sends rotational angle signals to the evaluating circuit during the adjusting movement as a measurement for the adjusting path that has been covered; these rotational angle signals are counted and the adjusting path Δz or the depth measurement to be determined is obtained from the sum.

Further, in an advantageous manner there is a foot switch for triggering the focusing movement, the calculation of the adjusting path Δz is carried out with a personal computer connected to the microscope, and a monitor connected to the personal computer serves as a display device. In this way, commercially available hardware and software can be economically used to realize the invention.

The invention is particularly suitable for use in stereo microscopes in which there are two microscope beam paths which are directed onto the observed object using the Greenough principle and are inclined relative to one another at a stereo angle of α≈10°-15°. In this way, it is possible for microscopes with a small depth of focus to be focused with great accuracy on different planes.

Further, in order to improve the focusing accuracy, a first stationary reticle marking and a second reticle marking which changes its position in a coordinate direction Y with the focusing movement can be provided in at least one of the beam paths, and a determined position in the coordinate Z corresponds in each instance to a determined position of the changing reticle marking in coordinate Y. The positions in the two coordinates satisfy the function z=y/sin α/2, where α is the stereo angle between two beam paths.

The accuracy of focus when using an arrangement of this kind is determined by the positioning accuracy of the focusing drive. Further possible steps for more precise focusing include post-magnification, which is already conventional in microscopy, and the use of auxiliary lens systems to be arranged between the Greenough system and the specimen.

Further, the adjustment can also be carried out with the two beam paths inclined relative to one another using the triangulation principle, wherein the reticle markings are stationary in both beam paths, while a next focus position of the measured object is focused upon and the reticle markings are also made to coincide within the depth of field by fine focusing. The depth measurement or height difference between the two different focusing planes is then likewise determined by evaluating the indicated positions and by subtraction as stated above.

In thc following, the invention will be described more fully with reference to an embodiment example.

### BRIEF DESCRIPTION OF THE DRAWINGS

In the drawings:

FIG. 1 shows the basic construction of the arrangement according to the invention with the schematic illustration of a microscope which is provided with a display and which is outfitted with a foot switch for initiating the focusing movement;

FIG. 2 shows a beam path of a stereo microscope which is directed at an angle α/2 onto the observed object;

FIG. 3 shows a reticle marking which is arranged in the beam path according to FIG. 2 and which changes position in direction of coordinate Y with the focusing movement; and

FIG. 4a illustrates the visual perception of the incompletely coinciding reticle marks when looking into the eyepiece of the stereo microscopes and FIG. 4b shows the coincidence of the two reticle markings with an ideal focus.

### DESCRIPTION OF THE PREFERRED EMBODIMENTS

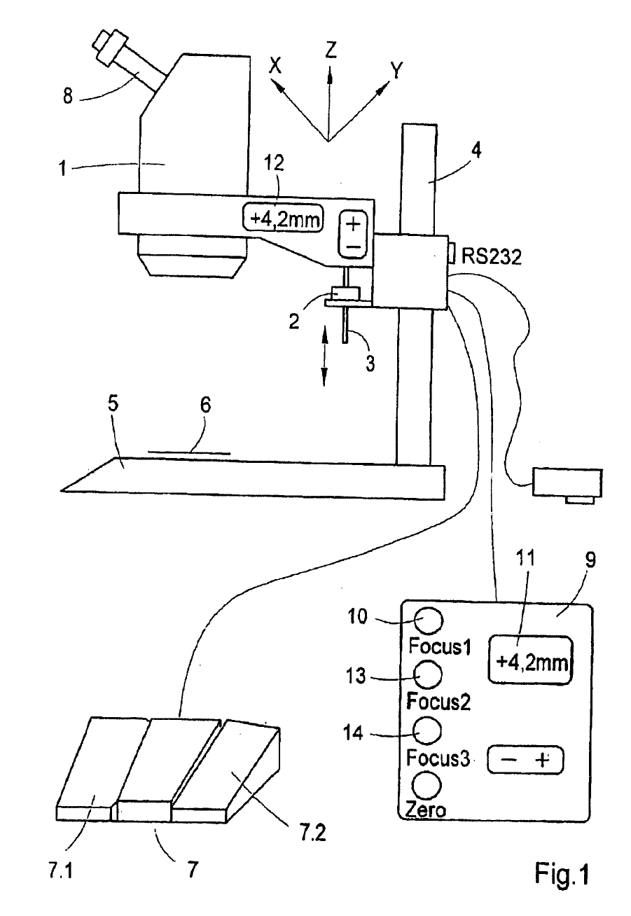

FIG. 1 shows a microscope body 1 which is outfitted with a motor drive unit 2, shown schematically, for the focusing movement in Z-coordinate direction. The motor drive unit 2 comprises a stepping motor from which the rotating movement of a threaded nut (not shown in the drawing) is transmitted to a threaded spindle 3 as longitudinal movement.

The longitudinal movement of the threaded spindle 3 causes the raising or lowering of the microscope body 1 in the Z-coordinate direction relative to a frame 4. A specimen stage 5 on which the specimen or the observed object 6 is deposited is fixedly connected to the frame 4.

The lifting or lowering movement of the microscope body 1 is triggered by actuating a foot switch 7 in which there are two foot pedals 7.1 and 7.2 which cause the stepping motor to run to the right or to the left and accordingly cause the microscope body 1 to be lifted or lowered for purposes of focusing.

During the focusing movement, the observed object 6 is observed through the microscope with tube 8 and the focus is monitored visually.

When the observed object 6 has a plurality of optical boundary layers which are staggered in depth in the Z-coordinate, for example, the measurement of depth or the measurement of distances between the individual boundary layers in direction of the optical axis is possible by means of the present construction.

First, an optical boundary layer located, for example, at position z₁ is focused upon. After focusing on this optical boundary layer, a button 10 is actuated at a manual control device 9 and causes the position z₁ to be indicated on a display 11 integrated in the manual control device 9 and/or on a display 12 arranged at the microscope body 1 by means of a path measuring system (not shown in detail) that is coupled with the drive unit 2.

It is also possible to send the value determined in this way to a PC by means of an RS 232 interface (only implied in FIG. 1) and to store this value in the PC.

In order to determine the distance in depth to a next selected optical boundary layer which lies, for example, at position z₂, this second optical boundary layer is now focused upon and position z₂ is displayed on the display 11 and/or 12 by pressing on a button 13. At the same time, position z₂ can be sent to the PC via the RS 232 interface and initially stored therein also.

Further, subtraction of positions z₁ and z₂ can be carried out by pressing on a button 14; the PC can be used for this purpose. In this case, the arrangement according to the invention is constructed in such a way that the difference Δz=z₁−z₂ can be read off on display 11 and/or on display 12 as a measurement for the depth between the two observed optical boundary layers.

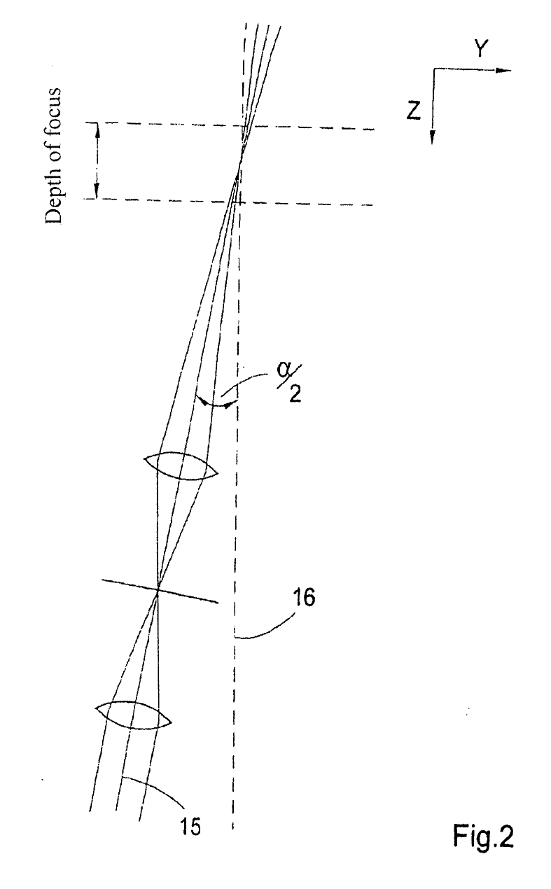

In order to increase accuracy when focusing on the individual focal planes, there can be two beam paths which are directed onto the observed object 6 according to the Greenough principle and are inclined relative to one another at a stereo angle α. This is shown schematically in FIG. 2 with only one of the two beam paths.

The optical axis 15 of the beam path is inclined relative to the device axis 16 by angle α/2; in FIG. 2, the plane described by coordinates Z and Y corresponds to the drawing plane. To this extent, both the optical axis 15 and device axis 16 lie in the drawing plane. The device axis 16 is directed parallel to the coordinate Z.

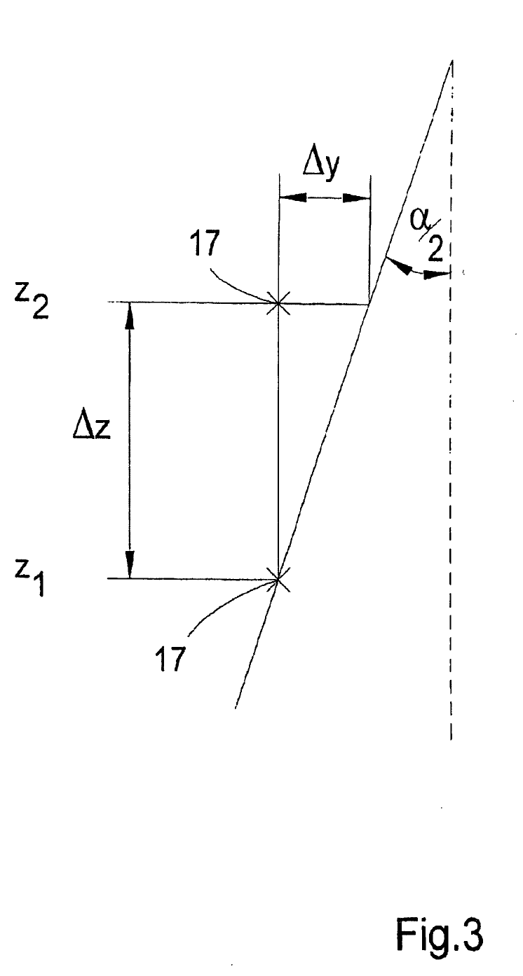

A reticle marking 17 which changes its position in the direction of coordinate Y with the focusing movement is provided in the optical axis 15 of the beam path, as is shown in FIG. 3. This is also true in an analogous sense for the other beam path of the stereo microscope that is not shown.

A focus position for which both reticle markings coincide can be adjusted within the depth of focus with the reticle markings which are present in both beam paths of the microscope. This improved focusing is used, according to the invention, to achieve a greater accuracy in depth measurement.

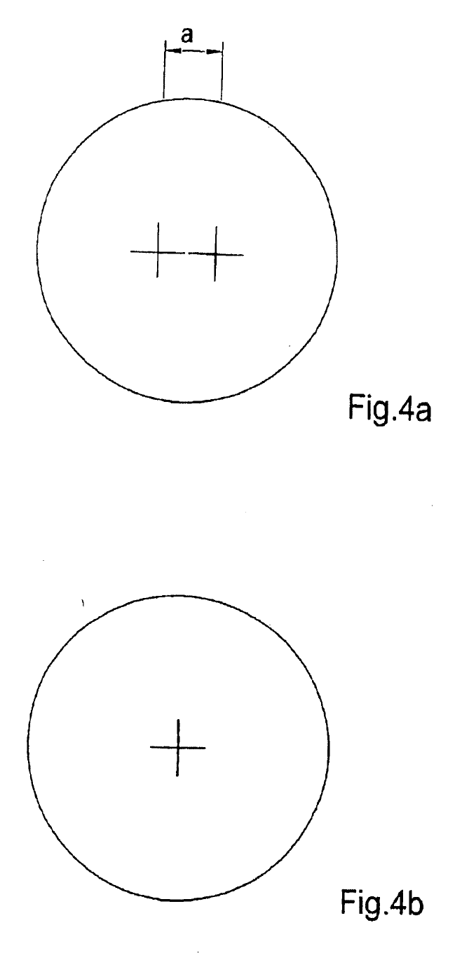

In this connection, FIG. 4a shows the visual perception of the incompletely coinciding reticle markings when looking into the eyepiece of the stereo microscope; the distance between the two reticle markings indicates that focusing has not yet been carried out in an optimal manner. In contrast, FIG. 4b shows the coincidence of the two reticle markings with an ideal focus.

While the foregoing description and drawings represent the present invention, it will be obvious to those skilled in the art that various changes may be made therein without departing from the true spirit and scope of the present invention.

Reference Numbers

1 microscope body
2 drive unit
3 threaded spindle
4 frame
5 specimen stage
6 observed object
7 foot switch
7.1, 7.2 foot pedals
8 tube
9 manual control device
10 button
11, 12 display
13, 14 button
15 axis
16 device axis
17 reticle marking
X, Y, Z coordinates
x, y, z positions
Δy amount
66 z adjusting path
α stereo angle

1. Arrangement for the focusing of microscopes, preferably for stereo microscopes, with a drive unit for the focusing movement in the Z-coordinate direction, with means for focusing on a plurality of different positions z₁, z₂ . . . zₙ located within an observed object on coordinate Z, with a path measuring system for determining the adjusting path Δz traveled when focusing initially on a first selected position z₁ and then on a second selected position z₂, and with a display device that is coupled with the path measuring system for displaying the selected positions z₁, z₂ and/or for displaying a measurement for the adjusting path Δz.

2. Arrangement according to claim 1, characterized in that the path measuring system is coupled with the motor drive unit.

3. Arrangement according to claim 1 or 2, characterized in that a stepping motor is provided as drive unit and the measurement for the adjusting path Δz is obtained from the quantity of drive steps required for the adjusting path Δz.

4. Arrangement according to one of the preceding claims, characterized in that the path measuring system and/or the display device has a computation circuit by means of which the value of “zero” is set for the first selected position z₁ and the second selected position z₂ is outputted as a measurement for the adjusting path Δz that has been traveled.

5. Arrangement according to one of the preceding claims, characterized in that a foot switch is provided for triggering the focusing movement, the adjusting path Δz is determined by means of a personal computer connected to the microscope, and a monitor connected to the personal computer serves as a display device.

6. Arrangement for focusing for stereo microscopes with two microscope beam paths which are directed onto the observed object using the Greenough principle and are inclined relative to one another at a stereo angle of α=10°-15°, characterized in that there are stationary reticle markings in both beam paths which change their apparent position within the object in the direction of coordinate Y with the focusing movement, wherein one of the positions z₁, z₂ . . . zₙ is allocated to a determined position of the reticle markings in the coordinate direction y.

7. Arrangement according to claim 6, characterized in that a position y of the reticle marking and the position z₁, z₂ . . . zₙ allocated to it correspond to the function z=y/sin α, where α is the stereo angle between the two beam paths.
